(19) United States
(12) Patent Application Publication
(10) Pub. No.: US 2012/0085591 A1
(43) Pub. Date: Apr. 12, 2012

(54) Tree stand

(76) Inventor: John Gregory Williams, Walhalla, SC (US)

(21) Appl. No.: 12/925,024

(22) Filed: Oct. 12, 2010

(51) Int. Cl. A01M 31/02; E04G 5/00

(52) U.S. Cl. 182/129

(57) ABSTRACT

A tree stand that includes a seating section and a standing section. Each section includes a first frame, a second frame, a first engaging member, a second engaging member that is responsive to a pneumatic piston, a pivoting gate member, and a support platform. The support platform in the seating section of the tree stand is a seat. The support platform in the standing section is a standing platform. A tree stand is positioned onto a tree by opening the pivoting gate member so that the tree trunk can be received into the first frame and thereby engage the first engaging member and the “V” shaped tooth side of the second engaging member. As the user ascends or descends the tree, the second engaging member is adjusted to compensate for changes in tree diameter by removing and replacing a tethered retaining pin.

### RELATED APPLICATIONS

Not Applicable.

### STATEMENT AS TO RIGHTS TO INVENTIONS MADE UNDER FEDERALLY SPONSORED RESEARCH AND DEVELOPMENT

Not Applicable.

### PARTIES TO A JOINT RESEARCH AGREEMENT

Not Applicable.

### SEQUENCE LISTING

Not Applicable.

### BACKGROUND OF THE INVENTION

(1) Field of the Invention

This invention is directed towards a portable tree stand that can be used by person's such as hunters for observing wildlife from an elevated and secure platform where such platform consists of a seating section and a standing section which are capable of providing a safe ascent and descent of a tree by its user.

(2) Description of the Related/Prior Art

The use of portable tree stands for hunters and other outdoors persons to ascend a tree to an elevated observation position is well known in the prior art. Many of these portable tree stands have a seating section and a standing section that are attached to the tree trunk and are manipulated by the user in some manner to adjust for changes in the diameter of the tree trunk during ascent or descent.

Many of the portable tree stands incorporate flexible belts, straps, cables, chains, or similar flexible components to attach the sections of the tree stand to the tree trunk. This approach is used in U.S. Pat. Nos. 7,306,074 B2, 7,258,200 B2, 6,988,588 B2, 6,668,976 B2, 6,182,792 B1, and 4,113,057. Other portable tree stands often utilize a rigid member, or members, constructed of metal to attach the sections of the tree stand to the tree trunk. This approach is used in U.S. Pat. Nos. 5,090,505, 4,834,217, and Des. 354,143. Both of these configurations result in the attachment element (i.e., belt, strap, cable, chain, or a metal rigid member) becoming a load bearing member because the weight of the tree stand section and the weight of the user is positioned on the opposite sides of the tree trunk from the attachment member and as such may interfere with the adjusting of the attachment member as the diameter of the tree changes. Additionally, flexible belts, straps, cables, and even some light weight chains are subject to the stresses of wear and tear that may eventually lead to a failure in the attachment member which in turn may result in injury. Finally, all the above attachment mechanisms may be subject to malfunction or difficult to operate due to their complexity or should the user fail to properly maintain or prevent debris from accumulating on or within the attachment mechanism.

Accordingly, there remains room for improvement and variation within the art.

### SUMMARY OF THE INVENTION

The present invention is directed to a tree stand for ascending and descending trees, or other similar objects, that is simple and safe to use. It is therefore a primary objective of this invention to provide such a tree stand by eliminating the use of belts, cables, chains, and such other devices that wrap around the tree and require frequent adjustments by the user.

Another object of the present invention is to provide a tree stand with a means for attaching the tree stand to a tree, or other similar objects, that will not be subjected to the stresses of use that may lead to a failure of the attaching means.

Another object of the present invention is to provide a tree stand with a means for attaching the tree stand to a tree, or similar object, that will remain effective without the necessity of routine maintenance.

Another object of the present invention is to provide a tree stand with a means for attaching the tree stand to a tree, or similar object, that is secure and simple to adjust.

The present invention is directed to a tree stand that satisfies these needs.

One aspect of one exemplary embodiment of the present invention provides for a tree stand that includes a first frame, a second frame, a first engaging member, a second engaging member, and a pivoting gate member. The second frame also serves to support the first frame. The first engaging member is located on the first frame. The second engaging member is located on the second frame and is responsive to a pneumatic piston. The pneumatic piston moves the second engaging member relative to its position with the second frame. The pivoting gate member is located within the first frame and may be opened or closed when the first frame is mounted to or removed from a vertical support such a tree.

Another aspect of the present invention provides for a tree stand as discussed above in which the first engaging member is located on the first end of the first frame and the second end of the first frame is attached to the second frame. Additionally, the first frame has a first frame lock and first and second inclined sides which connect the first and second ends of the first frame.

Another aspect of the present invention exists in a tree stand as immediately discussed in which the first engaging member is an inward facing cleat attached to the first end of the first frame.

An additional aspect of the present invention resides in a tree stand as previously discussed in which the pivoting gate member is located in the first inclined side of the first frame and includes a hinged first end and a gate lock second end. The pivoting gate member pivots outward to its open position to allow the first frame to be attached to a tree or other vertical support member. After the tree or other vertical support member is received into the first frame, the pivoting gate member pivots back to its closed position.

A further aspect of the present invention is found in a tree stand as previously discussed in which the gate lock second end of the pivoting gate member includes a male lock that secures the pivoting gate member in its closed position when the male lock is received by the first frame lock.

Another aspect of the present invention exists in a tree stand as described above in which the second engaging member has a “V” shaped toothed side for engaging a tree or other vertical support, a flat side that has a plurality of perpendicularly extending side bars, and a locking means for securing the second engaging member in a locked position.

Another aspect of the present invention is found in a tree stand as previously discussed in which the second frame has a pneumatic piston located at is first end and a support platform located at its second end.

An additional aspect of the present invention resides in a tree stand as previously discussed in which the first end of the second frame includes a horizontal cross member and a plurality of parallel hollow tubular sleeves. The parallel hollow tubular sleeves extend perpendicularly through the horizontal cross member and the first end and the second frame. The hollow tubular sleeves are positioned to slidably receive the side bars of the second engaging member.

A further aspect of the present invention is found in a tree stand as previously discussed in which the pneumatic piston extends perpendicularly from the horizontal cross member and traverses through the first end of the second frame which allows the pneumatic piston to engage the flat side of the second engaging member.

The present invention also provides for a tree stand that comprises a seating section that is used in tandem with a standing section. Both the seating section and the standing section include a first frame, a second frame, a first engaging member, and a pivoting gate member. The second frame of the also serves to support the first frame. The first engaging member is located on the first frame. The second engaging member is located on the second frame and is responsive to a pneumatic piston. The pneumatic piston moves the second engaging member relative to its position with the second frame. The pivoting gate member is located within the first frame and may be opened or closed when the first frame is mounted to or removed from a vertical support such a tree.

A further aspect of the present invention is found in a tree stand as previously discussed in which the first engaging member is located on the first end of the first frame and the second end of the first frame is attached to the second frame. Additionally, the first frame has a first frame lock and first and second inclined sides which connect the first and second ends of the first frame.

An additional aspect of the present invention resides in a tree stand as previously discussed in which the first engaging member is an inward facing cleat attached to the first end of the first frame.

Another aspect of the present invention is found in a tree stand as previously discussed in which the pivoting gate member is located in the first inclined side of the first frame and includes a hinged first end and a gate lock second end. The pivoting gate member pivots outward to its open position to allow the first frame to be attached to a tree or other vertical support member. After the tree or other vertical support member is received into the first frame, the pivoting gate member pivots back to its closed position.

Another aspect of the present invention exists in a tree stand as described above in which the gate lock second end of the pivoting gate member includes a male lock that secures the pivoting gate member in its closed position when the male lock is received by the first frame lock.

A further aspect of the present invention is found in a tree stand as previously discussed in which the second engaging member has a “V” shaped toothed side for engaging a tree or other vertical support, a flat side that has a plurality of perpendicularly extending side bars, and a locking means for securing the second engaging member in a locked position.

An additional aspect of the present invention resides in a tree stand as previously discussed in which the second frame has a pneumatic piston located at is first end and a support platform located at its second end.

Another aspect of the present invention exists in a tree stand as immediately discussed in which the first end of the second frame includes a horizontal cross member and a plurality of parallel hollow tubular sleeves. The parallel hollow tubular sleeves extend perpendicularly through the horizontal cross member and the first end and the second frame. The hollow tubular sleeves are positioned to slidably receive the side bars of the second engaging member.

A further aspect of the present invention is found in a tree stand as previously discussed in which the pneumatic piston extends perpendicularly from the horizontal cross member and traverses through the first end of the second frame which allows the pneumatic piston to engage the flat side of the second engaging member.

Another aspect of the present invention is found in a tree stand as previously discussed in which the support platform of the seating section is a seat and the support platform of the standing section is a standing platform.

These objects and other features, aspects, and advantages of the present invention will become better understood with reference to the following description and appended claims. The accompanying drawings, which are incorporated in and constitute part of the specification, illustrate embodiments of the invention and, together with the description, serve to explain the principles of the invention.

### BRIEF DESCRIPTION OF THE DRAWINGS

These and other features, aspects, and advantages of the present invention will become better understood with regard to the following description, appended claims, and accompanying drawings where:

FIG. 1 is a perspective view of the tree stand seating section with its pivoting gate member in the open position and its second engaging member in an extended position;

FIG. 2 is a perspective view of the tree stand standing section with its pivoting gate member in the open position and its second engaging member in an extended position;

FIG. 3 is a perspective view of the second engaging member;

FIG. 4A is an enlarged view of FIG. 1 showing the gate lock second end of the pivoting gate member and the first frame lock when the pivoting gate member is in its open position;

FIG. 4B is a view of FIG. 4A showing the gate lock second end of the pivoting gate member and the first frame lock when the pivoting gate member is in its closed position;

FIG. 5A is an enlarged view of FIG. 1 showing additional detail of the gate lock second end of the pivoting gate member and the first frame lock when the pivoting gate member is in its open position; and

FIG. 5B is a view of FIG. 5A showing additional detail of the gate lock second end of the pivoting gate member and the first frame lock when the pivoting gate member is in its closed position.

### DETAILED DESCRIPTION OF THE INVENTION

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

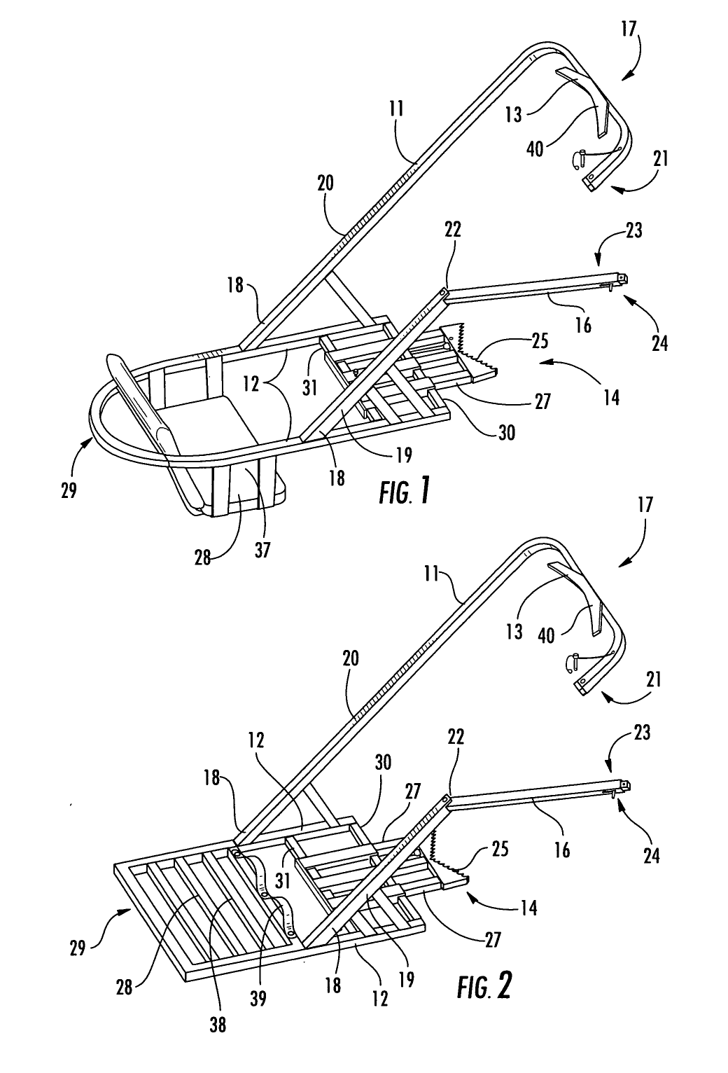

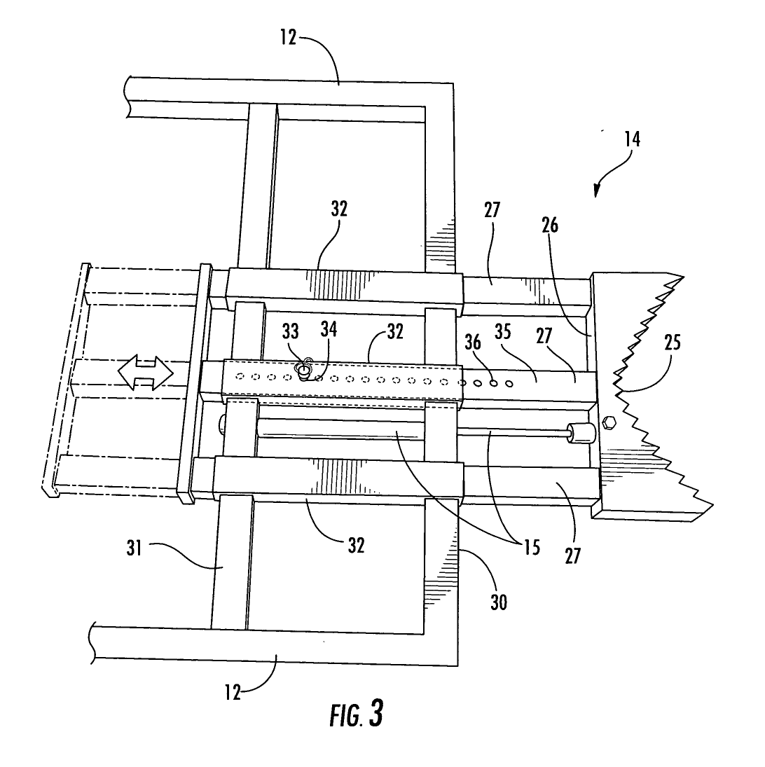

In referring more specifically to the drawings herein, FIG. 1 illustrates the seating section of a tree stand and FIG. 2 illustrates the standing section of a tree stand, it will be appreciated by those skilled in the art to which the invention relates that the seating section of a tree stand and the standing section of a tree stand share numerous components which are identical. In light of the presence of the same components in these sections of a tree stand, like components will share like numerals in FIG. 1 and in FIG. 2, as well as the other views illustrating various aspects of the invention.

Referring to FIG. 1 and FIG. 2 of the drawings, the tree stand includes a first frame 11, a second frame 12, a first engaging member 13, a second engaging member 14, and a pivoting gate member 16. The second frame 12 provides support to the first frame 11. The first engaging member 13 is supported by the first frame 11. The second engaging member 14 is supported by the second frame 12. The pivoting gate member 16 is shown in its open position in FIG. 1 as required to mount the tree stand to a tree or other vertical support. The pivoting gate member 16 is also shown in its open position in FIG. 2. As shown in FIG. 3 of the drawings, the tree stand also includes a pneumatic piston 15 to which the second engaging member 14 is responsive.

Continuing to refer to FIG. 1 and to FIG. 2, the first frame 11 has a first end 17 and a second end 18. The first engaging member 13 is attached to the first end 17 of the first frame 11. The second end 18 of the first frame 11 is attached to the second frame 12. The first frame 11 also includes a first inclined side 19, a second inclined side 20, and a first frame lock 21. The first inclined side 19 and the second inclined side 20 connect the first end 17 of the first frame 11 to the second end 18 of the first frame 11. An inward facing cleat 40 attached to the first end 17 of the first frame 11 and serves as the first engaging member 13.

Referring to FIG. 1 and FIG. 2 again, the pivoting gate member 16 is located within the first inclined side 19 of the first frame 11. The pivoting gate member has a hinged first end 22 and a gate lock second end 23. The hinged first end permits the pivoting gate member to swing outward to its open position for placing the tree stand onto a tree trunk or other vertical support.

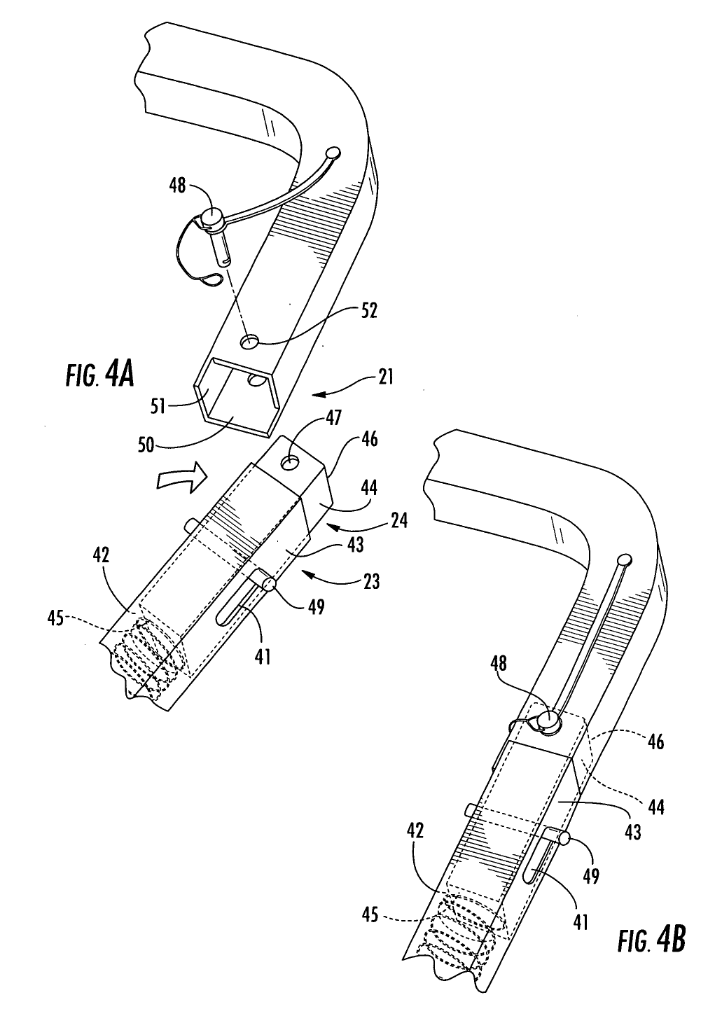

FIGS. 4A and 4B illustrate a configuration of the gate lock second end 23 and the first frame lock 21 that can be operated with one hand. FIG. 4A shows the gate lock second end and the first frame lock when the pivoting gate member is in its open position. FIG. 4B shows the gate lock second end and the first frame lock when the pivoting gate member is in its closed position. Continuing to refer to FIG. 4A and FIG. 4B, the gate lock second end includes parallel horizontal slots 41 on the inner 42 and outer 43 vertical surfaces of the first frame. The male lock 24 is slidably received by the first frame and is typically a length of rectangular metal stock 44 that has a spring biased inner end 45 and a male outer end 46. The male outer end has a vertical aperture 47 for receiving a tethered first retaining pin 48. A handle 49 extends horizontally outward through the length of rectangular metal stock 44 and said parallel horizontal slots 41 for moving the male lock 24 against the action of said spring. The first frame lock 21 has a lower edge 50 that extends from the bottom horizontal surface of the first frame, an inner edge 51 that extends from the inner vertical surface of the first frame, and a vertical aperture 52 that coincides with the vertical aperture of the male outer end when pivoting gate member is in its closed position. The pivoting gate member is locked into its closed position by inserting the tethered first retaining pin into the coinciding apertures of the male outer end and the first frame lock.

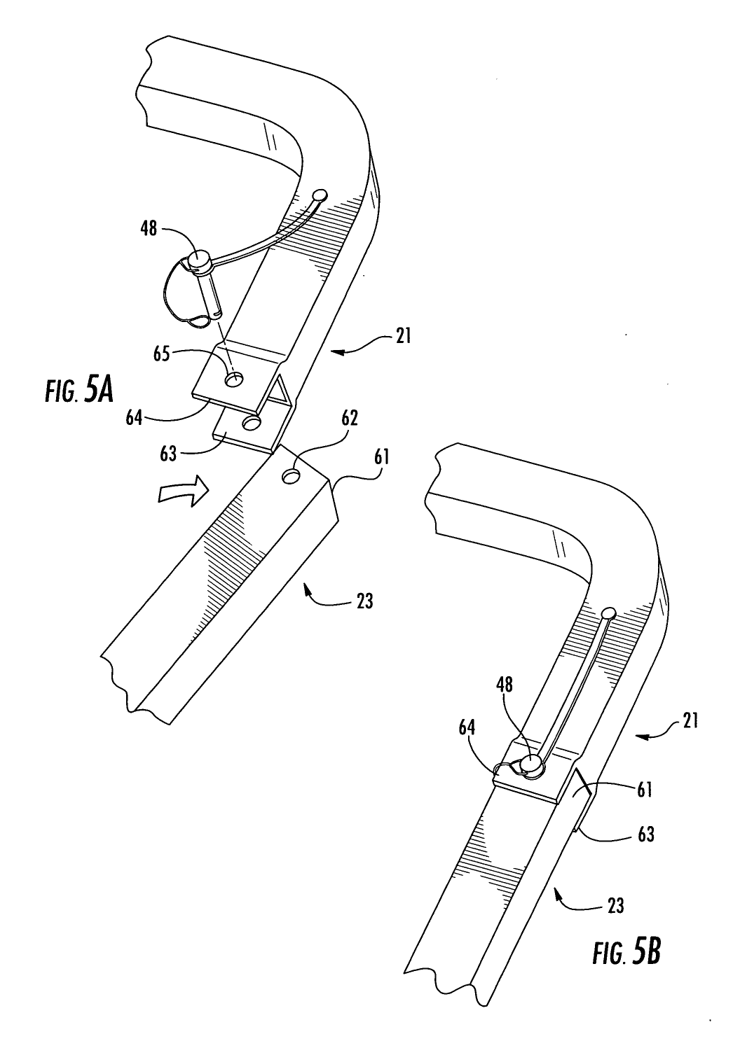

Another configuration of gate lock second end and the first frame gate lock that is simple to operate is illustrated in FIGS. 5A and 5B. FIG. 5A shows the gate lock second end 23 and the first frame lock 21 when the pivoting gate member is in its open position. FIG. 5B shows the gate lock second end and the first frame lock when the pivoting gate member is in its closed position. Continuing to refer to FIG. 5A and FIG. 5B, the gate lock second end includes a male outer end 61 and a vertical aperture 62. The first frame lock 21 has a lower edge 63 that extends from the bottom horizontal surface of the first frame, an upper edge 64 that extends from the upper horizontal surface of the first frame, and a vertical aperture 65 that coincides with the vertical aperture of the gate lock second end when the pivoting gate member is in its closed position. The pivoting gate member is locked into its closed position by inserting a tethered first retaining 48 pin into the coinciding apertures of the male outer end and the first frame gate lock.

Now referring to FIG. 1, FIG. 2, and FIG. 3, the second engaging member 14 has a “V” shaped toothed side 25 and a flat side 26. A plurality of side bars 27 extend perpendicularly from the flat side of the second engaging member. When the tree stand is mounted to a tree trunk or such other vertical support, the “V” shaped toothed side of the second engaging member engages the vertical support and thereby maintains the tree stand's position.

As illustrated in FIG. 1 and FIG. 2, and FIG. 3, the first end 30 of the second frame includes a horizontal cross member 31 and a plurality of parallel hollow tubular sleeves 32. The parallel hollow tubular sleeves extend perpendicularly through both the horizontal cross member and the first end of the second frame. Additionally, the parallel hollow tubular sleeves are positioned to slidably receive the plurality of side bars 27 extending from the flat side 26 of the second engaging member 14. Also as shown in FIG. 3, the second engaging member can be locked into position where a tethered second retaining pin 33 is inserted into a hollow tubular sleeve having a vertical aperture 34 that coincides with a side bar 35 having a plurality of vertically aligned apertures 36. Also shown in FIG. 3, the first end of the second frame includes a pneumatic piston 15. The pneumatic piston extends perpendicularly from the horizontal cross member 31 and traverses through the first end 30 of the first frame allowing it to be attached to the flat side 26 of the second engaging member 14.

Referring to FIG. 1 and FIG. 2, the second frame 12 includes a support platform 28 located at the second end 29 of the second frame. In the seating section of the tree stand as illustrated in FIG. 1 the support platform is a seat 37 upon which a user can sit when either adjusting the position of the tree stand, or sitting on the seat once the user has attained the desired height on the tree trunk or other vertical support. In the standing section of the tree stand as illustrated in FIG. 2, the support platform serves as a standing platform 38. Foot-straps 39 are attached to the standing platform and used by the climber to raise or lower the standing section of the tree stand when ascending or descending a tree or other vertical support.

To use the tree stand the standing section FIG. 2 is placed on the desired tree first. The tethered first retaining pin 48 is removed from the first frame lock 21 and the pivoting gate member 16 is swung outward to its open position. Next, the standing section is placed around the bottom of the tree so that the first engaging member 13 and the “V” shaped tooth side 25 of the second engaging member 14 engage the tree trunk. The pivoting gate member 16 is returned to its closed position and locked into place by inserting the tethered first retaining pin 48 into the vertical aperture 52, 65 of the first frame lock 21. The second engaging member is locked into position by aligning the proper vertically aligned aperture 36 of the side bar 35 with vertical apertures with the tubular sleeve vertical aperture 34 and inserting the tethered second retaining pin 33 into the coinciding apertures. The seating section FIG. 1 is placed onto the tree trunk slightly above the standing section by repeating the same procedure for attaching the standing section FIG. 2.

To begin an ascent of a tree the user steps over the back of the seating section and places his feet into the foot strap 39 of the standing platform 38. Next, the user squats down and grasps the first inclined side 19 and the second inclined side 20 near the second end 18 of the first frame 11 of the seating section and then pulls the seating section to a comfortable seating height. Once the seating section is securely in position, the user sits down on the seating section's seat 37 and with his feet in the foot straps 39 pulls the standing section upward. Once the standing section is pulled up, the user makes sure that standing section is securely attached to the tree trunk. This procedure is repeated until the user has reached the desired height.

As the user ascends the tree, the tree stand sections may become unlevel due to the decreasing diameter of the tree trunk. To make a leveling adjustment to the seating section the user puts his weight on the back of the seating section by gently sitting down and removes the tethered second retaining pin 33 from the tubular sleeve with the vertical aperture 34. Next, the user raises himself up from the seating section and the pneumatic piston 15 pushes the seating section up to a more level position. Once the desired level position is achieved, the second engaging member is locked into position by aligning the proper vertically aligned aperture 36 of the side bar 35 with the tubular sleeve vertical aperture 34 and inserting the tethered second retaining pin 33 into the coinciding apertures. To make a leveling adjustment to the standing section the user raises the standing section by pulling it up with the user's feet in the standing section's foot straps. When the standing section is at the desired level, the user removes the tethered second retaining pin 33 from the tubular sleeve with the vertical aperture 34 and allows the pneumatic piston 15 to pushes the standing section up to a more level position. Once the desired level position is achieved, the second engaging member is locked into position by aligning the proper vertically aligned aperture 36 of the side bar 35 with the tubular sleeve vertical aperture 34 and inserting the tethered second retaining pin 33 into the coinciding apertures.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention which is set forth in the following claims. In addition, it should be understood that aspects of the various embodiments may be interchanged, both in whole or in part. Therefore, the spirit and scope of the appended claims should not be limited to the description of the preferred versions contained therein.

What is claimed is:

1. A tree stand comprising:
a first frame;
a second frame, said second frame supporting said first frame;
a first engaging member supported by said first frame;
a second engaging member supported by said second frame and being responsive to a pneumatic piston for moving said second engaging member relative to said second frame; and
a pivoting gate member defined within said first frame, wherein said pivoting gate member may be opened or closed when said first frame is mounted to a vertical support.

2. The tree stand of claim 1, wherein said first frame is further defined by a first end supporting said first engaging member, a second end attached to said second frame, first and second inclined sides connecting said first end of said first frame to said second end of said first frame, and a first frame lock.

3. The tree stand of claim 1, wherein said first engaging member is further defined as an inward facing cleat attached to said first end of said first frame.

4. The tree stand of claim 1, wherein said pivoting gate member further defines said first inclined side of said first frame, said pivoting gate member pivots outward in its open position to receive said vertical support member, said pivoting gate member includes a hinged first end and a gate lock second end.

5. The tree stand of claim 4, wherein said gate lock second end is further defined by a male lock for securing said pivoting gate member in its closed position when received by said first frame lock.

6. The tree stand of claim 1, wherein said second engaging member is further defined by a “V” shaped toothed side for engaging said vertical support member, a flat side, and a plurality of side bars extending perpendicularly from said flat side.

7. The tree stand of claim 1, wherein said second frame is further defined by a support platform at a second end of said second frame and said pneumatic piston at a first end of said second frame.

8. The tree stand of claim 7, wherein said first end of said second frame is further defined by a horizontal cross member and a plurality of parallel hollow tubular sleeves extending perpendicularly through said horizontal cross member and said first end of said second frame, said hollow tubular sleeves being positioned to slidably receive said plurality of side bars extending perpendicularly from said flat side of said second engaging member.

9. The tree stand of claim 7, wherein said pneumatic piston extends perpendicularly from said horizontal cross member and traverses through said first end of said second frame allowing said pneumatic piston to engage said flat side of said second engaging member.

10. A tree stand comprising:
a seating section used in tandem with a standing section, wherein said seating section and said standing section each are further defined by a
a first frame;
a second frame, said second frame supporting said first frame;
a first engaging member supported by said first frame;
a second engaging member supported by said second frame and being responsive to a pneumatic piston for moving said second engaging member relative to said second frame; and
a pivoting gate member defined within said first frame, wherein said pivoting gate member may be opened or closed when said first frame is mounted to a vertical support.

11. The tree stand of claim 10, wherein said first frame of said seating section and of said standing section is further defined by a first end supporting said first engaging member, a second end attached to said second frame, first and second inclined sides connecting said first end of said first frame to said second end of said first frame, and a first frame lock.

12. The tree stand of claim 10, wherein said first engaging member of said seating section and of said standing section is further defined as an inward facing cleat attached to said first end of said first frame.

13. The tree stand of claim 10, wherein said pivoting gate member of said seating section and of said standing section further defines said first inclined side of said first frame, said pivoting gate member pivots outward in its open position to receive said vertical support member, said pivoting gate member includes a hinged first end and a gate lock second end.

14. The tree stand of claim 13, wherein said gate lock second end of said seating section and of said standing section is further defined by a male lock for securing said pivoting gate member in its closed position when received by said first frame lock.

15. The tree stand of claim 10, wherein said second engaging member of said seating section and of said standing section is further defined by a “V” shaped toothed side for engaging said vertical support member, a flat side, and a plurality of side bars extending perpendicularly from said flat side.

16. The tree stand of claim 10, wherein said second frame of said seating section and of said standing section is further defined by a support platform at a second end of said second frame and said pneumatic piston at a first end of said second frame.

17. The tree stand of claim 16, wherein said first end of said second frame of said seating section and of said standing section is further defined by a horizontal cross member and a plurality of parallel hollow tubular sleeves extending perpendicularly through said horizontal cross member and said first end of said second frame, said hollow tubular sleeves being positioned to slidably receive said plurality of side bars extending perpendicularly from said flat side of said second engaging member.

18. The tree stand of claim 16, wherein said pneumatic piston of said seating section and of said standing section extends perpendicularly from said horizontal cross member and traverses through said first end of said second frame allowing said pneumatic piston to engage said flat side of said second engaging member.

19. The tree stand of claim 16, wherein said support platform of said second frame of said seating section is a seat.

20. The tree stand of claim 16, wherein said support platform of said second frame of said standing section is a standing platform.
